(19) United States
(12) Patent Application Publication
(10) Pub. No.: US 2017/0294925 A1
(43) Pub. Date: Oct. 12, 2017

(54) Multi-Bit Digital To Analog-Optical Conversion Based On The Kerr Effect

(71) Applicant: Irfan Muhammad Fazal, Ottawa (CA)

(72) Inventor: Irfan Muhammad Fazal, Ottawa (CA)

(21) Appl. No.: 15/096,545

(22) Filed: Apr. 12, 2016

(51) Int. Cl. H04B 1/00; H04B 10/2575; H04J 14/02; G02F 1/01; G02F 1/35; G02F 1/365; G02B 6/27; H04J 14/06; H04B 10/556

(52) U.S. Cl. CPC H04B 1/0007; H04J 14/06; H04B 10/2575; H04J 14/02; H04B 10/5563; G02F 1/3511; G02F 1/365; G02B 6/2706; G02F 1/0136

(57) ABSTRACT

A digital-electrical to analog-optical converter for converting a N-bit digital data signal uses a non-linear optical element that is susceptible to the Kerr effect. N digitally modulated optical bit stream sources are co-polarized and modulated according to individual bit streams of the digital data. The co-polarized digitally modulated signals interact with a polarized probe signal in the optical element causing the polarization of the probe signal to be changed. Propagating the polarization-changed probe signal output from the optical element through a polarizer provides an amplitude modulated optical signal corresponding to the N-bit digital signal.

### TECHNICAL FIELD

The current disclosure relates to optical networks and in particular to a multi-bit digital-electrical to analog-optical converter.

### BACKGROUND

5^{th} generation, or 5G, cellular service will require several GHz of bandwidth to be supplied to individual cellular antennas. Radio over fiber (RoF) technology has the ability to scale to such high bandwidth requirements due to the THz of bandwidth provided by fiber optic cables. The fiber channel can also provide wavelength division multiplexing to accommodate a high number of wireless channels. Transmitting analog signals directly to a cellular antenna for transmission into free-space instead of transmitting digital data to the antenna and then converting the digital data to analog at the top of the antenna has an advantage of removing complexity from the remote antenna. In such RoF transmission systems, the digital to analog conversion may be done at a central office or at a remote distribution unit and an optical detector at the transmitter's antenna converts the transmitted radio frequency (RF) optical signal to an RF electrical signal for use in driving the antenna.

Several techniques have been proposed for the digital to analog conversion for use in RoF transmission systems. Some silicon photonics based modulators use the RF digital electrical signals to directly control multiple phase shifters located in an arm of a Mach-Zehnder interferometer (MZI) structure, which results in modulating an amplitude of the output optical signal. However, incorporating the electrically controlled phase shifters into a single MZI structure requires the individual phase shifters to be disposed in close physical proximity to each other, which can result in crosstalk between the RF electrical signals applied to individual phase shifters. Other modulators may reduce the RF crosstalk by using separate optical wavelengths for each digital bit stream, which allows the RF electrical bit signals to be physically separated; however, such modulation results in spectral inefficiency since each individual bit stream is modulated by a separate wavelength and as such a multi-bit signal will be modulated by multiple different wavelengths. Further, walk-off between different wavelengths over a long length of fiber would require compensation, increasing the system complexity.

An additional, alternative and/or improved digital to analog modulator for use in converting a multi-bit digital electrical signal to a corresponding analog optical signal is desired.

### SUMMARY

In accordance with the present disclosure there is provided a digital to analog converter (DAC) for converting an N-bit digital electrical signal into a corresponding analog optical signal, the DAC comprising: N digitally modulated optical bit stream sources each configured for modulating a respective optical signal according to a respective bit bₙ of the N-bit digital-electrical signal, where b₁ is a most significant bit and b_{N} is a least significant bit of the N-bit electrical-digital signal, wherein the optical signals output from each of the N digitally modulated optical bit stream sources are co-polarized; a non-linear optical element susceptible to the Kerr effect, the non-linear optical element optically coupled to outputs of the N digitally modulated optical bit stream sources, wherein when a probe optical signal source having an initial polarization relative to the N co-polarized optical signal and having an optical frequency of f_{probe} is optically coupled to the non-linear optical element, the optical signal of each of the N digitally modulated optical bit stream sources cause a corresponding change of the polarization of the probe optical signal; and a polarizer coupled to an output of the non-linear optical element for polarizing the probe optical signal.

In a further embodiment, the DAC further comprises an optical filter coupled to the polarizer for outputting optical signals having the optical frequency of f_{probe}.

In a further embodiment of the DAC, each of the N co-polarized digitally modulated optical signals output from the N digitally modulated optical bit stream sources has a distinct optical frequency of fₙ, for n=1 . . . N.

In a further embodiment of the DAC, fᵢ is closer to a zero dispersion frequency of the non-linear waveguide than fᵢ₊₁, for i=1 . . . N−1.

In a further embodiment of the DAC, at least one of the N digitally modulated optical bit stream sources comprises: a laser outputting a continuous wave optical signal at an optical frequency of fₙ; and a polarization controller for adjusting a polarization of the continuous wave optical signal.

In a further embodiment of the DAC, the at least one digitally modulated optical bit stream source further comprises an attenuator for attenuating an amplitude of the optical signal output from the laser.

In a further embodiment of the DAC, the at least one digitally modulated optical bit stream source further comprises a modulator for digitally modulating the optical signal output from the laser according to the bit bₙ of the N-bit digital-electrical signal.

In a further embodiment of the DAC, the laser comprises a directly modulated laser for outputting a digitally modulated optical signal that is modulated according to the bit bₙ of the N-bit digital-electrical signal.

In a further embodiment of the DAC, the initial polarization of the probe signal is at 45° relative to polarization of the N co-polarized optical sources.

In a further embodiment of the DAC, the non-linear waveguide is one of: a length of highly non-linear optical fiber (HNLF); and a highly non-linear optical waveguide.

In accordance with the present disclosure there is further provided a radio over fiber (RoF) system for transmitting an analog radio-frequency signal to a transmission location, the RoF system comprising: a plurality of DACs as described above; a wavelength multiplexer for multiplexing the analog optical signals output from the optical filters of the plurality of DACs into a single output optical signal; a wavelength demultiplexer for demultiplexing the analog optical signals; and an optical fiber coupling the wavelength multiplexer to the wavelength demultiplexer.

In a further embodiment, the RoF system further comprises a plurality of transmitters each located at a respective one of the plurality of transmission locations and coupled to a respective one of the analog optical signals output from the wavelength demultiplexer, each of the transmitters comprising: a photo detector for converting the respective analog optical signal to a corresponding radio frequency (RF) electrical signal; an electrical amplifier for amplifying the RF electrical signal to an RF driving signal; and an antenna for radiating the RF driving signal in free space.

In a further embodiment of the RoF system, each of a plurality of optical fibers coupling the analog optical signals output from the wavelength demultiplexer to the respective transmitters have a respective length of less than 800 m.

In a further embodiment of the RoF system, the optical fiber coupling the wavelength multiplexer to the wavelength demultiplexer is between 0 km and 20 km in length.

In a further embodiment of the RoF system, the non-linear optical element of one or more of the plurality of DACs comprises one of a highly non-linear fiber (HNLF) or highly non-linear waveguide (HNLF) component.

In accordance with the present disclosure there is further provided a method of converting an N-bit digital-electrical signal to a corresponding analog-optical signal comprising: digitally modulating N optical signals according to N bit streams of the N-bit digital-electrical signal, the N digitally modulated optical signals being co-polarized; combining the N digitally modulated signals with a probe optical signal being polarized at an angle to the co-polarized digitally modulated optical signals in a non-linear optical element susceptible to the Kerr effect; and passing an output of the non-linear optical element through a polarizer to provide an output analog optical signal having an amplitude corresponding to the N-bit digital-electrical signal.

In a further embodiment, the method further comprises non-linearly transforming the N-bit digital-electrical signal for modulating the N optical signals.

In a further embodiment of the method, the probe optical signal is polarized at approximately 45° degrees to the N co-polarized digitally modulated optical signals.

In a further embodiment of the method, the polarizer is arranged at 90° degrees to the N co-polarized digitally modulated optical signals.

In a further embodiment of the method, the non-linear optical element comprises a highly non-linear fiber (HNLF) or a highly non-linear waveguide (HNLW) component.

### BRIEF DESCRIPTION OF THE DRAWINGS

Embodiments are described herein with reference to the appended drawings, in which:

FIG. 1 depicts polarizer outputs for different input signals;

FIG. 2 depicts various optical signals in a converter based on a non-linear optical element susceptible to the Kerr effect;

FIG. 3 depicts the evolution of the probe signal's polarization on a Poincaré sphere;

FIGS. 4A-4C depict different states of polarization of a probe output relative to a polarizer;

FIG. 5 depicts a converter based on a non-linear optical element susceptible to the Kerr effect;

FIG. 6 depicts a further converter based on a non-linear optical element susceptible to the Kerr effect;

FIG. 7 depicts optical signals in a converter based on a non-linear optical element susceptible to the Kerr effect

FIG. 8 depicts further optical signals in a converter based on a non-linear optical element susceptible to the Kerr effect; and

FIG. 9 depicts a radio over fiber (RoF) transmission system incorporating a digital-electrical to analog-optical converter based on a non-linear optical element susceptible to the Kerr effect.

### DETAILED DESCRIPTION

A digital-electrical to analog-optical converter is described herein that provides an analog optical signal that corresponds to a digital electrical signal. The converter is described with particular reference to its use in a radio-over-fiber (RoF) application; however, it may be used in other applications in which it is desirable to carry an analog version of a digital signal over a fiber optic cable. The converter described herein provides low radio frequency (RF) crosstalk by providing physical separation between RF electrical signals of the multi-bit electrical data. The converter does not rely on electrically controlled phase-shifters located in an arm of a Mach-Zehnder interferometer (MZI) and as such, it is possible to provide sufficient physical separation between the electrical signals to reduce the RF crosstalk to acceptable or desired levels. Further, the converter described herein may provide high spectral efficiency since each multi-bit RF electrical signal can be modulated on a single wavelength, allowing multiple modulated multi-bit RF signals to be multiplexed onto a single fiber optic cable. Further, the converter structure may be implemented in a simple structure using a relatively low number of optical cells. As described in further detail, the converter may provide a high resolution of at least 8-10 bits while maintaining a high signal to noise ratio. The converter can provide high spectral efficiency for wavelength division multiplexing (WDM) applications.

As described further below, the digital-electrical to optical-analog conversion is based on a non-linear optical element that is susceptible to the Kerr effect. The Kerr effect is a non-linear optical effect that changes the index of refraction of the optical element based on an optical intensity of an input signal or signals. The change in the index of refraction is different for different polarizations and propagation directions. The non-linear optical element may be considered as an optical-intensity dependent birefringent element. The non-linear optical element is coupled to a plurality of pump optical signals that modulate an optical signal according to a bit stream of the multi-bit electrical signal. The plurality of modulated pump signals interact with a probe signal within the non-linear optical element and change the polarization of the probe signal. By passing the probe signal output from the non-linear optical element through a polarizer an optical signal can be obtained that has an amplitude that is proportional to the digital-electrical signal. The digital-electrical to analog-optical conversion process separates the conversion process into two stages, the first stage converts the digital-electrical signal to a digital-optical signal, or signals. The second stage combines the digital-optical signal or signals to a single analog-optical amplitude modulated signal. Separating the conversion process into the stages as described allows the physical separation of the RF electrical signals.

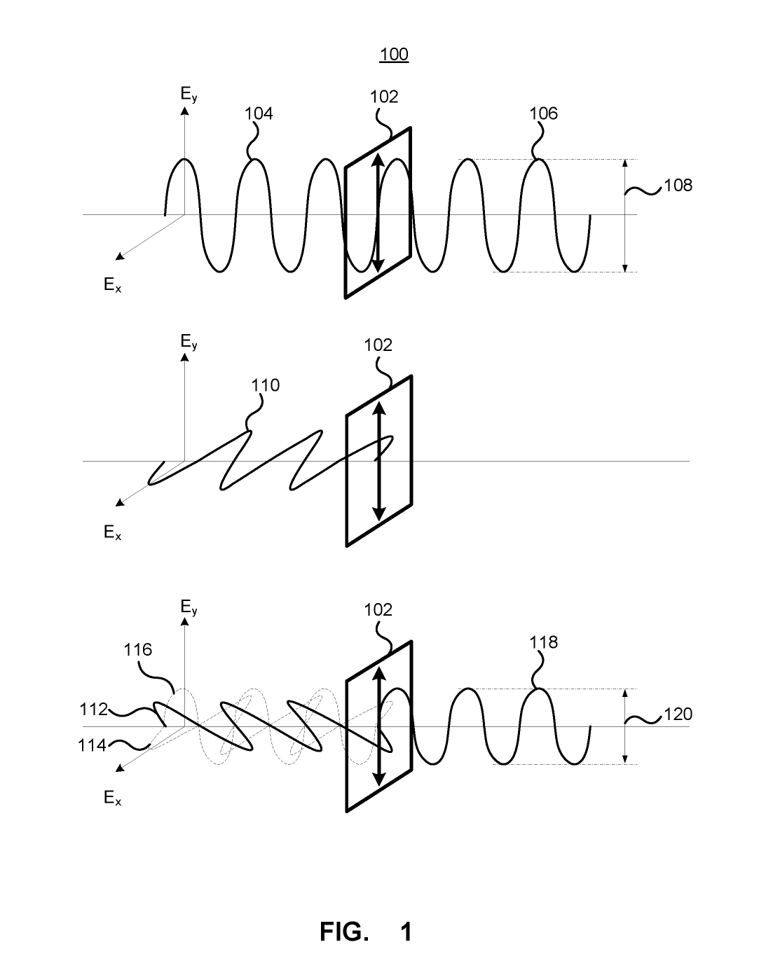

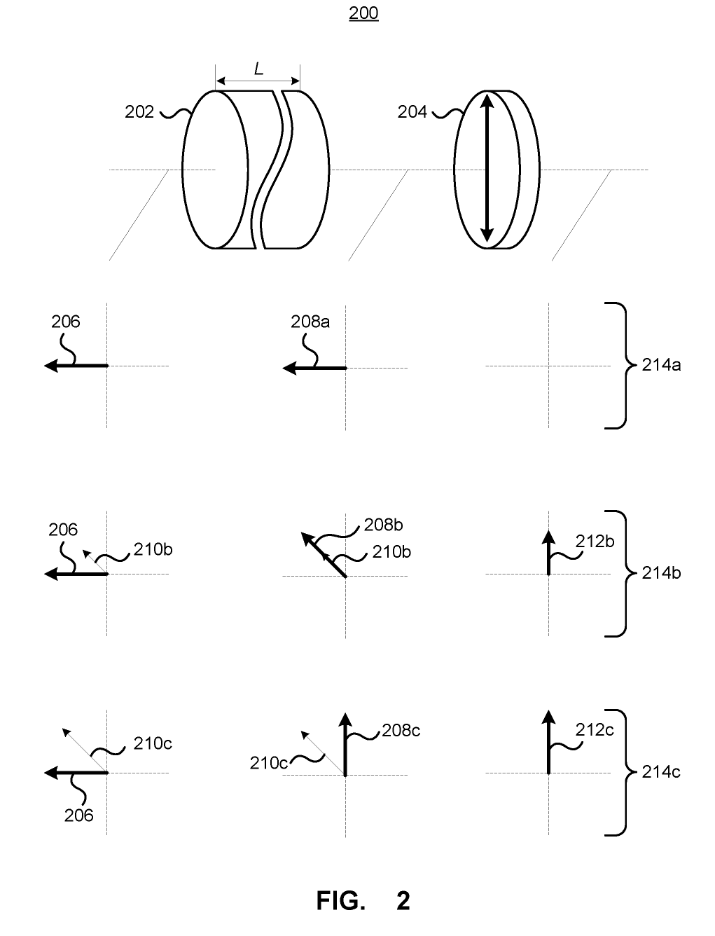

FIG. 1 depicts polarizer outputs for different input signals. A vertical polarizer 102 allows vertically polarized signals 104 to pass through. The output 106 from the polarizer 102 is a vertically polarized signal having a particular amplitude that corresponds to the amplitude of the vertically polarized component of the input. As depicted in FIG. 1, when the input signal 104 is vertically polarized, the output amplitude 108 will be substantially the same as the input amplitude. It will be appreciated that the amplitude may be lower due to non-ideal properties of the polarizer 102. A horizontally polarized signal 110 has no vertically polarized component and as such, when it is input to the vertical polarizer 102, there is no output from the polarizer 102. When a polarized input signal 112 that has both a horizontal polarization component 114, which may be referred to as Eₓ, and a vertical polarization component 116, which may be referred to as E_{y}, is passed through the vertical polarizer 102, output signal 118 will have an amplitude 120 corresponding to the amplitude of the vertically polarized component 116. As depicted in FIG. 1, the amplitude of an optical signal passing through a vertical polarizer corresponds to the initial polarization of the input signal. As described further below with reference to FIG. 2 the Kerr effect allows the polarization of a signal to be changed based on the intensity of a second signal.

FIG. 2 depicts various optical signals in a converter based on a non-linear optical element that is susceptible to the Kerr effect. The converter 200 comprises the non-linear optical element 202 that is susceptible to the Kerr effect. The non-linear optical element is depicted as a length, l, of a highly non-linear fiber (HNLF). The non-linear optical element 202 changes the polarization of a input probe signal 206 based on an intensity of a pump signal 210b, 210c. The output probe signal 208a, 208b, 208c from the non-linear optical element component 202 passes through a polarizer 204. The resulting amplitude of the output signal 212b, 212c from the polarizer 204 will depend upon the polarization of the output probe signal 208a, 208b, 208c output from the non-linear optical element 202.

FIG. 2 depicts the output signals from the polarizer associated with three different scenarios. In a first scenario 214a, there is no pump signal input to the non-linear optical element 202 and as such the polarization of the probe signal 206 remains unchanged, as depicted by the un-rotated output probe signal 208a. The output probe signal 208a is depicted as a horizontally polarized signal and as such there is no output when passed through the vertical polarizer component 204. In a second scenario 214b, the same probe signal 206 is provided to the non-linear optical element 202, however a pump signal 210b having a particular amplitude is also provided to the non-linear optical element 202. The pump signal 210b has a polarization of 45° relative to the polarization of the probe signal 206. Accordingly, one of the polarization components of the probe signal 206 will be affected by the change in the refractive index of the non-linear optical element 202 caused by the pump signal 210b, while the other orthogonal polarization component of the probe signal 206 will not experience a change in the refractive index. Since one polarization component of the probe signal 206 experiences a change in refractive index while the orthogonally polarized component does not experience a change in the refractive index, the resulting polarization of the output probe signal 208b will be changed. It is noted that the change in the refractive index experienced by one of the polarization components may result in a circular, or elliptical polarization of the output probe signal 208b. Since the polarization of the output probe 208b signal has been changed, when the signal passes through the polarizer 204, the output signal 212b will have an amplitude determined according to the polarization. In a third scenario, the same probe signal 206 is provided to the non-linear optical element 202 along with a pump signal 210c that is polarized at 45° relative to the probe signal 206. As depicted, the pump signal 210c has a larger amplitude than the pump signal 210b, which results in a greater amount of change of the polarization of the probe signal 206 within the non-linear optical element 202. As depicted, the probe signal 206 is rotated by 90° and as such, the output signal 212c has a greater amplitude than the output signal 212b. It is noted that rotation of the probe signal 206 by 90° is intended as a graphical representation. The actual change in the polarization may not be a rotation by 90° but rather a change to an elliptical or circular polarization.

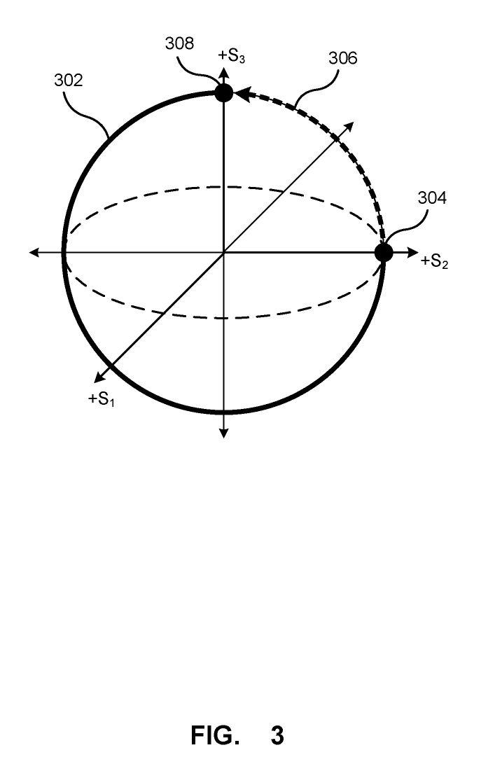

FIG. 3 depicts the evolution of the probe signal's polarization on a Poincaré sphere 302. A first polarization 304 of the probe signal is depicted as being located on the horizontal axis S2, which corresponds to a 45° linear polarization. As a phase shift between the two polarization components Ex, Ey of the probe signal increases, the polarization traverses the Poincaré sphere 302 as represented by broken arrow 306, which corresponds to an elliptical polarization. As the phase shift between the two polarization components Ex, Ey increases from 0 to 90°, the polarization evolves from the 45° linear polarization 304 to an elliptical polarization to a circular polarization 306. Accordingly, a 90° delay in the phase of one of the two polarization components with respect to the other one of the two polarization components, which may be due to a change in the refractive index of the non-linear optical component from one or more pump signals, results in rotating the probe output polarization from linear polarization to circular polarization.

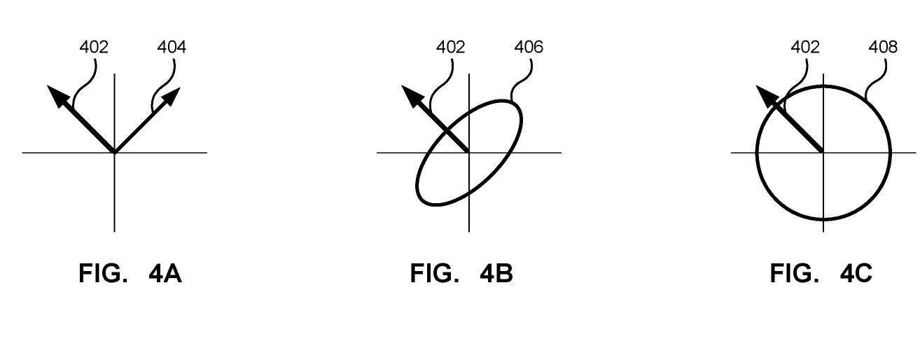

FIGS. 4A-4C depict different states of polarization of a probe output relative to a polarizer. As depicted in FIG. 4A, a polarizer may be arranged so that it's polarization, depicted as arrow 402, is orthogonal to the linearly polarized probe signal, depicted as arrow 404. With the polarization of the probe signal orthogonal to the polarizer, there is no output. As a phase shift between the two polarization components of the probe signal increases from 0°, the state of polarization of the probe becomes elliptical, as depicted by ellipse 406 of FIG. 4B. As the polarization of the is changed to an elliptical polarization, a portion of the polarization will align with the polarizer and as such the output from the polarizer will begin to increase. As the phase shift between the two polarization components of the probe signal increases to 90°, resulting in a circular polarization of the probe signal, depicted as circle 408 of FIG. 4C. The circular polarization depicted in FIG. 4C will l correspond to ½ the initial optical power of the probe signal, ignoring any non-ideal losses.

Returning to FIG. 2, as depicted the amplitude of a probe signal 206 passing through a polarizer 204 can be varied by changing the polarization of the probe signal 206 before it passes through the polarizer. The polarization of the probe signal 206 may be rotated, or changed, within the non-linear optical element 202 based on an amplitude of one or more pump signals provided to the non-linear optical element. As described further below, the combination of the non-linear optical element 202 to adjust the polarization of a signal and a polarizer 204 to adjust the amplitude of the signal based on the polarization is used to provide a digital-electrical to analog-optical converter.

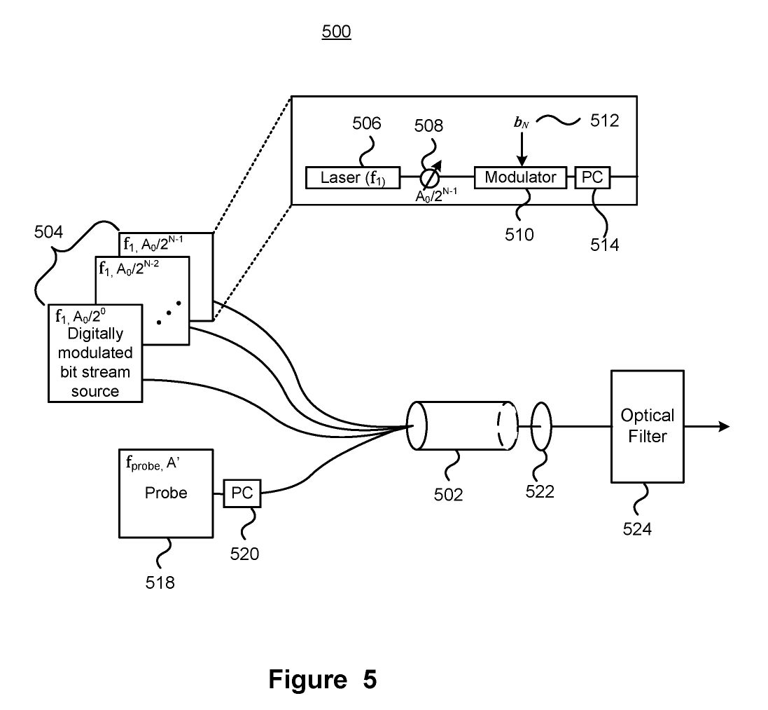

The amount of rotation or change in the polarization of a signal may depend on the amplitude of a pump signal as well as a length of the non-linear optical element and characteristics of the non-linear optical element. The longer the non-linear optical element the greater the amount rotation or change, assuming other characteristics of the non-linear optical element remain the same. In addition to the length of the non-linear optical element, and the amplitude of the pump signal, the amount of rotation or change may also depend upon the optical frequency of the pump signal as described in further detail with reference to FIG. 5.

FIG. 5 depicts a digital-electrical to analog-optical converter based on the Kerr effect. The converter 500 comprises highly non-linear optical element, such as a waveguide or fiber, 502. As depicted a plurality, N, of digitally modulated optical bit stream sources 504 are coupled to the non-linear optical element 502. Each of the digitally modulated bit stream sources 504 provides an optical signal that is modulated, or turned off and on, according to a corresponding bit of the digital data being modulated. As depicted, each of the digitally modulated bit stream sources 504 may comprise a laser source 506 that provides a continuous wave optical signal to an attenuator 508 that attenuates the amplitude of the signal according to the bit being modulated, which as depicted in FIG. 5 is

$$\frac{{A}_{0}}{{2}^{N}}$$

for the N^{th}, or least significant, bit 512. The attenuated signal is modulated according to a bit 512 of the digital signal, depicted as the N^{th} bit, by a modulator 510. The polarization of the signal may be adjusted by an optional polarization controller (PC) 514. The polarization controller 514 adjusts the polarization of the digitally modulated optical signal so that all of the N digitally modulated bit stream sources provide co-polarized optical signals. It will be appreciated that the attenuator 508 may be located in different positions along the optical path. For example, the attenuator 508 may be located after the modulator 510. Similarly, the polarization controller 514 may be located at different positions along the optical path.

A probe signal 518 is provided to the non-linear optical element 502. The probe signal 518 is depicted as having an optical frequency of f_{probe} and an amplitude of A_{probe}. The polarization of the probe signal 518 is adjusted by a polarization controller 520. The probe signal and the pump signals are polarized at 45° relative to each other.

Each of the N digitally modulated bit stream sources 504 is depicted as having the same optical frequency of f₁, although as described further below it is possible to use different optical frequency assignments. The polarization rotation of the probe signal 518 within the non-linear optical element 502 depends on the amplitudes of the pump signals 504. Accordingly, the amplitude of the pump signal for each of the bit stream sources 504 is set so that the pump signal will induce a particular rotation of the polarization of the probe signal corresponding to the significance of the bit modulating the pump signal. For example, the amplitude of the pump signal modulated by the most significant bit of the digital signal will be larger than the amplitude of the pump signal modulated by the least significant bit. For an N-bit data, defined as

$$B = {\sum }_{i = 1 … N} \frac{{b}_{i}}{{2}^{i - 1}} ,$$

where bᵢ is a bit stream with b₁ being the most significant bit stream and b_{N} being the least significant bit stream, the amplitude of the digitally modulated bit stream signal may be defined by

$$\frac{{A}_{0}}{{2}^{N - n}}$$

for n=1 . . . N. A₀ is selected such that a pump signal having an amplitude of

$${\sum }_{n = 1 … N} \frac{{A}_{0}}{{2}^{N - n}}$$

will induce a polarization rotation of 90° in the probe signal within the non-linear optical element 502.

For example, for a 2-bit signal, the amplitude of the signal modulated by the most significant bit would induce a rotation of 60° and the amplitude of the signal modulated by the least significant bit would induce a rotation of 30°. Accordingly, as highlighted in Table 1, when combined together, the two modulated bit stream signals can produce 4 different rotations in the polarization of the probe signal, and as such, 4 corresponding amplitudes.

TABLE 1
depicting associated probe signal rotations and output amplitudes

| | | | MSB | LSB | Total | Output |
|---|---|---|---|---|---|---|
| Value | MSB | LSB | Rotation | Rotation | Rotation | Amplitude |
| 0 | 0 | 0 | 0° | 0° | 0° | $\frac{0}{3} \frac{{A}_{probe}}{2}$ |
| 1 | 0 | 1 | 0° | 30° | 30° | $\frac{1}{3} \frac{{A}_{probe}}{2}$ |
| 2 | 1 | 0 | 60° | 0° | 60° | $\frac{2}{3} \frac{{A}_{probe}}{2}$ |
| 3 | 1 | 1 | 60° | 30° | 90° | $\frac{3}{3} \frac{{A}_{probe}}{2}$ |

The optical signals from each of the modulated bit stream sources 504 cause the polarization of probe signal 518 to be changed. The amplitude and frequency of the optical signals modulated by the digital bit streams are set so that when all of the modulated signals are cony, the probe signal's polarization is rotated by 90°. The output of the non-linear optical element 502 is coupled to a polarizer 522 that is a linear polarizer arranged at 90° to the original polarization of the probe signal 518. Accordingly, when all of the modulated digital signals from the sources 504 are cony the probe signal's polarization is rotated by 90° and all of the probe signal 518 passes through the polarizer 522 resulting in the largest amplitude of the output signal. When all of the modulated digital signals 504 are ‘off’ the polarization of the probe signal 518 is not rotated and as such the optical signal output from the non-linear optical element 502 is blocked by the polarizer 522. In order to provide a single output signal, an optical filter may be provided 524 that outputs the probe signal's optical frequency.

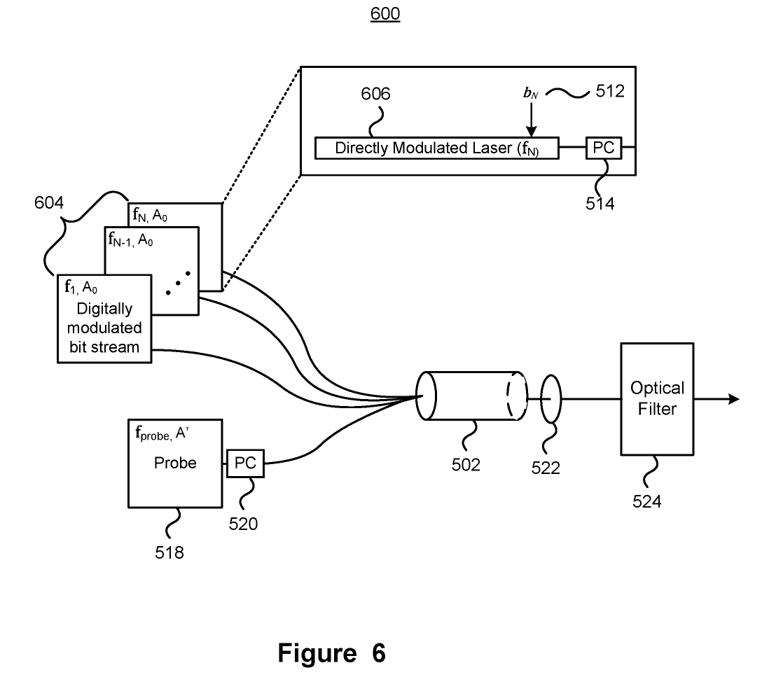

FIG. 6 depicts a further digital-electrical to analog-optical converter based on the Kerr effect. The converter 600 is substantially similar to the converter 500 described above; however, the digitally modulated bit stream sources 604 each have different optical frequencies rather than different amplitudes. As depicted each of the modulated bit stream sources 604 may be provided by a respective laser source 606 operating at a specific optical frequency of fₙ for n=1 . . . N. In contrast to the bit stream sources 504 described above, which included a separate modulator, the bit stream sources 604 comprise directly modulated laser source 606 that is modulated by a respective bit stream 512 of the electrical data. The polarizations of the optical signals of the modulated bit stream sources 604 are adjusted by the respective polarization controllers 514 so that all of the optical signals have the same polarization. The Kerr effect is dependent upon frequency walk-off and as such, the amount of polarization rotation induced in the probe signal can be controlled by modulated pump signals having different optical frequency. As a frequency difference between the probe and pump signals increases, the Kerr effect decreases due to pulse walk-off caused by fiber dispersion. By assigning optical frequencies to the modulated bits so that the least significant bit modulates an optical signal having an optical frequency that is the farthest from the probe signal's optical frequency the induced polarization rotation can be controlled in order to provide digital to analog conversion. The optical frequencies of the probe and pump signals may be located about a zero-dispersion wavelength of the non-linear optical element 602.

The converters 500 and 600 described above used either different amplitudes of signals of the same optical frequency, or signals of different optical frequencies with the same amplitude in order to induce a polarization rotation of a probe signal corresponding to the bit significance of the bit being modulated. It will be appreciated that the two techniques may be combined together. In particular, for an N-bit signal, where n=1 associated with the most significant bit and n=N associated with the least significant bit, the amplitude and optical frequency of the respective pump signal for each of the N digitally modulated bit streams may be selected so as to induce a rotation of the polarization of the probe signal of

$$( N - n + 1 ) ( \frac{90 °}{{2}^{N} - 1} )$$

according to the bit bₙ being modulated.

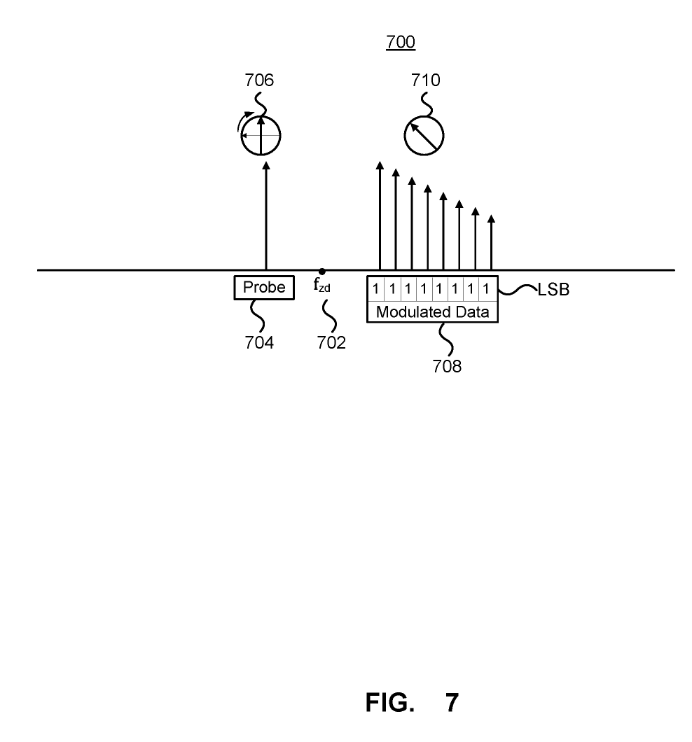

FIG. 7 depicts optical signals in an Kerr-based converter. As depicted in FIG. 7, both the optical frequencies and amplitudes of the digitally modulated bit stream pump signals are varied in order to control an amount of rotation induced in the polarization of the probe signal. The optical frequencies of the modulated optical signals 708 are selected so that the optical frequency of the optical signal modulated by the least significant bit is the furthest away from the optical frequency of the probe signal 704. As depicted, a zero-dispersion frequency f_{zd} of the non-linear optical element may be located between the wavelength of the probe signal and the wavelengths of the pump signals used in modulating the data 708. All of the pump signals modulating data 708 are co-polarized with the polarization, represented by arrow 710, being at 45° to the polarization of the probe signal. When all of the pump signals are modulating a bit of ‘1’ and as such are present as depicted in FIG. 7, the Kerr effect rotates the polarization of the probe signal 90°, as depicted by arrow 706.

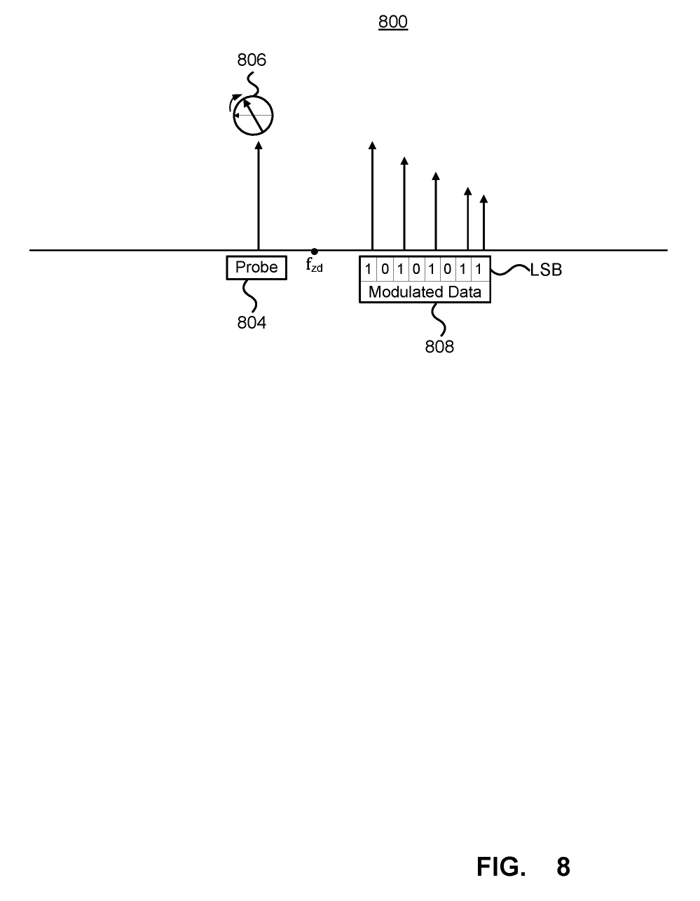

FIG. 8 depicts further optical signals in an non-linear optical element susceptible to the Kerr effect. As depicted, when the modulating data 808 includes ‘0’ bits, the pump signals corresponding to those bits will be modulated to a 0 amplitude and as such will not be present in the non-linear optical element. As such the Kerr-effect will induce less rotation of the polarization of the probe signal 804, compared to the scenario depicted in FIG. 7, as depicted by the arrow 806.

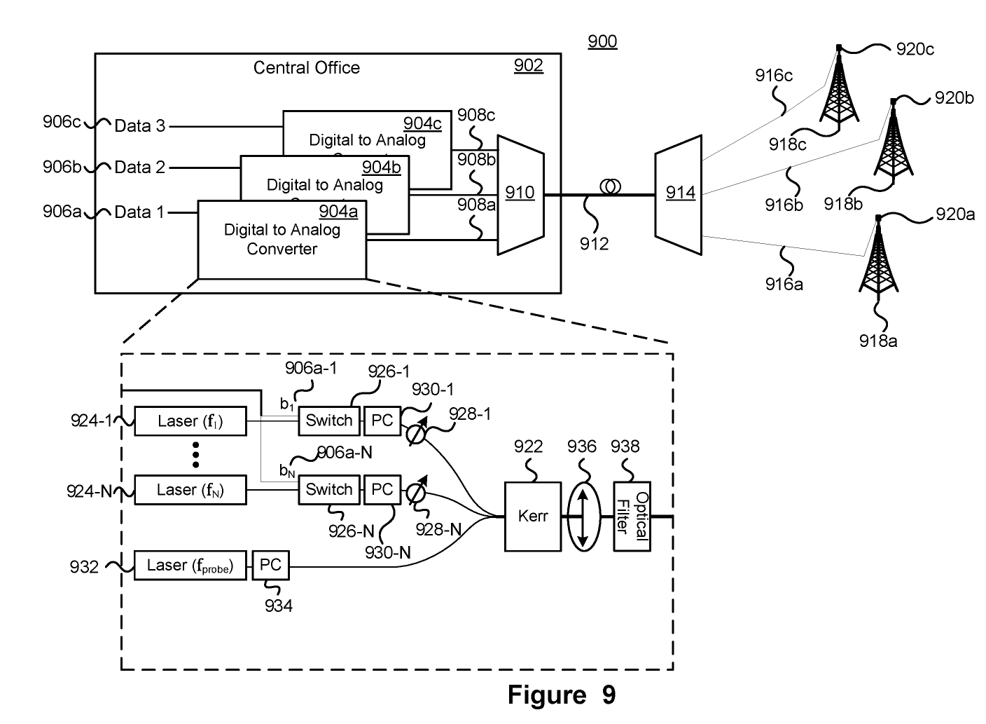

FIG. 9 depicts a radio over fiber (RoF) transmission system 900 incorporating a digital-electrical to analog-optical converter. The RoF system 900 comprises a central office 902 at which digital data is converted into an analog optical signal that can be transmitted over optical cables to remote locations. As depicted, the central office 902 may comprise a plurality of digital-electrical to analog-optical converters 904a-904c (referred to collectively as digital to analog converters 904) that each convert a multi-bit digital electrical signal 906a-906c (referred to collectively as digital-electrical signals 906) to a corresponding analog-optical signal 908a-908c (referred to collectively as analog-optical signals 908). Although shown located at the central office 902, the digital-electrical to analog-optical converters 904a-904c may be located at any location where digital-electrical to analog-optical conversion is performed. Each of the analog-optical signals 908 may be an amplitude modulated signal at a particular wavelength. If each of the analog-optical signals 908 are at different wavelengths, the plurality of analog-optical signals 908 can be multiplexed into a single output signal by a wavelength multiplexer 910. The output signal, which may comprise a plurality of analog-optical signals multiplexed together, can be transmitted over a fiber optic cable 912. The fiber optic cable 912 may be connected between the multiplexer 910 and a demultiplexer 914. The fiber optic cable 912 may carry the output signal a relatively large distance such as up to 20 km or more. The demultiplexer 914 demultiplexes each of the optical signals 908 output from the digital to analog modulators 904. The demultiplexer 914 may be coupled to a plurality of transmitters 920a-920c (referred to collectively as transmitters 920) by a relatively short length of fiber optic cables 916a-916c (referred to collectively as fiber optic cables 916). The length of the fiber optic cables 916 coupling the demultiplexer 914 to the transmitters 920 may be for example up to 900 m or more. As depicted, each of the transmitters 920 may be located at respective cell sites 918a-918c (referred to collectively as cell sites 918). The cell sites may be located at separate physical locations as depicted in FIG. 9, or may be separate cell sectors located at the same physical location. Each of the transmitters may include an optical detector for converting the analog optical signal to an analog electrical signal for use in driving the transmitter antenna.

Each of the digital to analog converters 904 generates an amplitude modulated analog-optical signal 908 that corresponds to the digital-electrical data signals 906 that comprises a multi-bit digital signal. For example, each of the digital-electrical data signals 906 may comprise 8 or 10 bit signals. Each of the digital to analog converters 904 converts electrical data into a corresponding optical signal. Each of the converters 904 may comprise a plurality, N, of lasers 924-1-924-N that each provide a continuous wave optical signal at a particular optical frequency fᵢ for i=1 . . . N. Each of the optical signals is modulated by a modulator, which may be an optical switch 926-1-926-N, that is controlled by a bit respective bit stream of the data 906-1-906-N. Each of the modulated optical signals is attenuated by respective attenuators 928-1-928-N so that the amplitude of the optical signal corresponds to the bit significance of the bit stream being modulated. The amplitude and optical frequency of each modulated optical signal is selected to change a polarized probe signal by a particular amount corresponding to the bit being modulated. The polarization of the optical pump signals is adjusted by respective polarization controllers (PC) 930-1, 930-N so that all of the pump signals have the same polarization that is at 45° relative to the polarization of the probe signal. The modulated optical pump signals are coupled to the non-linear optical element 922 that is susceptible to the Kerr effect. Further, the polarization of the probe optical signal, provide by a probe laser 932 with an optical frequency of f probe may be adjusted by a polarization controller 934 so that it is at 45° relative to the polarization of the pump signals. The modulated optical pump signals cause the polarization of the pump signal to change. The optical signals from the non-linear optical element 922 are passed through a linear polarizer 936 that is arranged at 90° to the original polarization of the probe signal and an optical filter that passes the probe wavelength and blocks the other signals, such as the pump signals. The output from the optical filter 938 is an amplitude modulated optical signal whose amplitude corresponds to the N-bit data signal.

Digital to analog converters described above are based on Kerr-non-linearity or Kerr-shutter utilizing polarization rotation of a probe signal under optical intensity-induced birefringence caused by a co-propagating pump signal. As described N optical signals are digitally modulated according to N bit streams of the N-bit digital-electrical signal. The N digitally modulated optical signals are co-polarized and are combined with a probe optical signal that is polarized at an angle to the co-polarized digitally modulated optical signals within the non-linear optical element that is susceptible to the Kerr effect. The output of the non-linear optical element is passed through a polarizer to provide an output analog optical signal having an amplitude corresponding to the N-bit digital-electrical signal. The non-linear optical element is susceptible to the Kerr effect and may be, for example, a highly non-linear fiber (HNLF) where for short-haul applications the fiber channel itself provides the non-linear optical element. Alternatively, the non-linear optical element could be a highly non-linear waveguide (HNLW) which may provide a small footprint and high-speed scalability. As described above, the converter architecture can be divided into two sections or modules. In one module ‘N’ RF digital bits of an N bit signal are converted into N independent optical bits by modulating them on N independent modulators, which may be provided by, for example Si—Ph based Mach Zehnder modulators. The optical source for the N digital modulators operate at a spectral position relative to a zero-dispersion wavelength of the HNLF/non-linear media. The second module comprises the Kerr-based non-linear optical element. Each of the N RF digital optical signals are fed into the non-linear optical element along with a continuous wave probe signal. The N-digitally modulated signals are co-polarized and act as pump signals in the non-linear optical element. The pump signals are co-polarized and aligned at an angle of 45 degrees to the polarization orientation of the probe signal. The two polarization components of the probe signal will ‘see’ different refractive indexes within the non-linear optical element as one component does not see any optical-field induced variation in its refractive index, while the other component that is aligned with polarization orientation of the N-pumps will experience a change in its refractive index depending on the optical-field provided by the pumps. The power of the N-pumps is tuned such that each pump provides

$$( N - n + 1 ) \frac{90 °}{{2}^{N} - 1}$$

polarization rotation to the probe signal. At the output of the non-linear optical element is a linear polarizer aligned orthogonally to the default polarization of the probe signal. Therefore, when all the N-pumps are ON the probe signal is rotated by 90 degrees aligning it with the output polarization and the maximum amplitude of the probe signal is output from the polarizer, while when all the probe signals are OFF, the polarization of the probe signal is un-perturbed and remains orthogonal to the output polarizer and there is no light at the output. This effectively creates an all-optical N-bit adder for the N digital bit streams and converts the digital signals to an N-level analog signal. An optical filter may be provided after the polarizer so that only the probe signal is transmitted on to the optical channel. In short-haul applications where it is possible to use the HNLF as the fiber channel, the polarizer can be placed at the receiver end.

The transfer function of the digital-to-analog conversion described above will generally have a nonlinear response, e.g. sine squared or cosine squared response. While such a response may be acceptable, or desirable, in some applications, it is often desirable to provide a more linear transformation. To make the transformation linear, a digital to digital converter that changes the non-linearity of the cosine squared response to a linear response may be used. Alternatively, a power assignment lookup table may be used that can modify the modulu-2 power assignment to a linear power assignment. Known techniques for transforming a cosine squared response to a linear response, e.g. digital-to-digital transformation techniques, may be used for this purpose.

The above has described various functionality provided by various systems or components. Although specific embodiments are described herein, it will be appreciated that modifications may be made to the embodiments without departing from the scope of the current teachings. Accordingly, the scope of the appended claims should not be limited by the specific embodiments set forth, but should be given the broadest interpretation consistent with the teachings of the description as a whole.

What is claimed is:

1. A digital to analog converter (DAC) for converting an N-bit digital electrical signal into a corresponding analog optical signal, the DAC comprising:
N digitally modulated optical bit stream sources each configured for modulating a respective optical signal according to a respective bit bₙ of the N-bit digital-electrical signal, where b₁ is a most significant bit and b_{N} is a least significant bit of the N-bit electrical-digital signal, wherein the optical signals output from each of the N digitally modulated optical bit stream sources are co-polarized;
a non-linear optical element susceptible to the Kerr effect, the non-linear optical element optically coupled to outputs of the N digitally modulated optical bit stream sources, wherein when a probe optical signal source having an initial polarization relative to the N co-polarized optical signal and having an optical frequency of f_{probe} is optically coupled to the non-linear optical element, the optical signal of each of the N digitally modulated optical bit stream sources cause a corresponding change of the polarization of the probe optical signal; and
a polarizer coupled to an output of the non-linear optical element for polarizing the probe optical signal.

2. The DAC of claim 1, further comprising an optical filter coupled to the polarizer for outputting optical signals having the optical frequency of f_{probe}.

3. The DAC of claim 1, wherein each of the N co-polarized digitally modulated optical signals output from the N digitally modulated optical bit stream sources has a distinct optical frequency of fₙ, for n=1 . . . N.

4. The DAC of claim 3, wherein fᵢ is closer to a zero dispersion frequency of the non-linear waveguide than fᵢ₊₁, for i=1 . . . N−1.

5. The DAC of claim 1, wherein at least one of the N digitally modulated optical bit stream sources comprises:
a laser outputting a continuous wave optical signal at an optical frequency of fₙ; and
a polarization controller for adjusting a polarization of the continuous wave optical signal.

6. The DAC of claim 5, wherein the at least one digitally modulated optical bit stream source further comprises an attenuator for attenuating an amplitude of the optical signal output from the laser.

7. The DAC of claim 6, wherein the at least one digitally modulated optical bit stream source further comprises a modulator for digitally modulating the optical signal output from the laser according to the bit bₙ of the N-bit digital-electrical signal.

8. The DAC of claim 5, wherein the laser comprises a directly modulated laser for outputting a digitally modulated optical signal that is modulated according to the bit bₙ of the N-bit digital-electrical signal.

9. The DAC of claim 1, wherein the initial polarization of the probe signal is at 45° relative to polarization of the N co-polarized optical sources.

10. The DAC of claim 1, wherein the non-linear waveguide is one of:
a length of highly non-linear optical fiber (HNLF); and
a highly non-linear optical waveguide.

11. A radio over fiber (RoF) system for transmitting an analog radio-frequency signal to a transmission location, the RoF system comprising:
a plurality of DACs of claim 2;
a wavelength multiplexer for multiplexing the analog optical signals output from the optical filters of the plurality of DACs into a single output optical signal;
a wavelength demultiplexer for demultiplexing the analog optical signals; and
an optical fiber coupling the wavelength multiplexer to the wavelength demultiplexer.

12. The RoF system of claim 11, further comprising:
a plurality of transmitters each located at a respective one of the plurality of transmission locations and coupled to a respective one of the analog optical signals output from the wavelength demultiplexer, each of the transmitters comprising:
a photo detector for converting the respective analog optical signal to a corresponding radio frequency (RF) electrical signal;
an electrical amplifier for amplifying the RF electrical signal to an RF driving signal; and
an antenna for radiating the RF driving signal in free space.

13. The RoF system of claim 12, wherein each of a plurality of optical fibers coupling the analog optical signals output from the wavelength demultiplexer to the respective transmitters have a respective length of less than 800 m.

14. The RoF system of claim 11, wherein the optical fiber coupling the wavelength multiplexer to the wavelength demultiplexer is between 0 km and 20 km in length.

15. The RoF system of claim 11, wherein the non-linear optical element of one or more of the plurality of DACs comprises one of a highly non-linear fiber (HNLF) or highly non-linear waveguide (HNLF) component.

16. A method of converting an N-bit digital-electrical signal to a corresponding analog-optical signal comprising:
digitally modulating N optical signals according to N bit streams of the N-bit digital-electrical signal, the N digitally modulated optical signals being co-polarized;
combining the N digitally modulated signals with a probe optical signal being polarized at an angle to the co-polarized digitally modulated optical signals in a non-linear optical element susceptible to the Kerr effect; and
passing an output of the non-linear optical element through a polarizer to provide an output analog optical signal having an amplitude corresponding to the N-bit digital-electrical signal.

17. The method of claim 17, further comprising non-linearly transforming the N-bit digital-electrical signal for modulating the N optical signals.

18. The method of claim 17, wherein the probe optical signal is polarized at approximately 45° degrees to the N co-polarized digitally modulated optical signals.

19. The method of claim 17, wherein the polarizer is arranged at 90° degrees to the N co-polarized digitally modulated optical signals.

20. The method of claim 17, wherein the non-linear optical element comprises a highly non-linear fiber (HNLF) or a highly non-linear waveguide (HNLW) component.
